(19) United States
(12) Patent Application Publication
(10) Pub. No.: US 2021/0318648 A1
(43) Pub. Date: Oct. 14, 2021

(54) IMAGE FORMING CONTROL APPARATUS AND IMAGE FORMING APPARATUS

(71) Applicant: Konica Minolta, Inc., Tokyo (JP)

(72) Inventor: Sho OKUZAWA, Tokyo (JP)

(21) Appl. No.: 17/227,688

(22) Filed: Apr. 12, 2021

(30) Foreign Application Priority Data
Apr. 14, 2020 (JP) 2020-072286

(51) Int. Cl. G03G 15/00

(52) U.S. Cl. CPC G03G 15/50

(57) ABSTRACT

Provided is an image forming control apparatus including a first detection section that detects an image for detection formed on a recording medium, a second detection section that detects the image for detection formed on the recording medium on a further downstream side than the first detector in a conveyance direction of the recording medium, and a hardware processor that controls an image forming apparatus such that the image forming apparatus starts a preparation operation of image forming processing after detection in the first detection section and forms an image for printing on the recording medium based on detection timing in the second detection section.

### CROSS REFERENCE TO RELATED APPLICATIONS

This present invention claims priority under 35 U.S.C. § 119 to Japanese Patent Application No. 2020-072286 filed on Apr. 14, 2020, the entire content of which is incorporated herein by reference

### BACKGROUND

### Technological Field

The present invention relates to an image forming control apparatus and an image forming apparatus.

### Description of Related Art

In some cases, in an image forming apparatus such as multifunctional peripherals or a printer, an additional printing for forming an image for printing (an additional printing image) is performed on a recording medium (e.g., a continuous sheet) on which an image has been previously formed. When the additional printing is performed, an image referred to as an eye mark is formed on the recording medium in advance. The eye mark serves as a trigger of timing to start formation of the additional printing image in performing the additional printing, and a black square is usually used therefor.

In one example, when the additional printing is performed on a continuous sheet as the recording medium, an image and an eye mark are formed in advance on the continuous sheet. After the continuous sheet is conveyed for the additional printing, an eye mark detection section detects the eye mark of the continuous sheet, and formation of an additional printing image is started at this detection timing as a trigger. For example, the detection timing serves as writing timing of the additional printing image on a photoconductor drum of an image forming section in the image forming apparatus, and thus, the additional printing image can be formed on a desired position of the continuous sheet. As a result, the additional printing image can be formed on a position matching the pre-printed image.

As such an image forming apparatus, for example, Japanese Patent Application Laid-Open No. 2008-87186 discloses a printing apparatus including a printing means that performs printing a belt-like sheet on which eye marks are formed at equal intervals, a sheet conveyance means that conveys the sheet, an eye mark detection section that detects an eye mark of the sheet on upstream side of the printing means, and/or the like. Further, Japanese Patent Application Laid-Open No. 2008-087186 discloses that the eye mark detection section is movable in a sheet conveyance direction or in its reverse direction.

Meanwhile, when printing is performed by detecting an eye mark in an image forming apparatus, as described above, image forming processing is started at the detection timing of the eye mark as a trigger. Hence, the image forming processing is always required to stand by in a state where the apparatus is capable of starting the image forming processing so as to respond whenever the eye mark is detected.

In an image forming apparatus, a component related to image forming processing, for example, a photoconductor drum of an image forming section takes time to stabilize from the start of rotational driving; thus, such component is required to be rotationally driven during a standby state as well as during image forming. Due to this, when a standby time becomes longer, the rotationally driving component abrades (wears) more quickly, which affects component life.

Therefore, for example, as Japanese Patent Application Laid-Open No. 2008-087186 describes, to secure a sufficient preparation time for stabilizing the photoconductor drum, a position of the eye mark detection section may be moved to increase a conveyance distance of the continuous sheet between the eye mark detection section and the image forming section. Thus, increasing the conveyance distance between the eye mark detection section and the image forming section enables the photoconductor drum to stabilize its rotational driving before the image forming processing, even when the photoconductor drum starts rotational driving after the eye mark detection section detects the eye mark.

However, in the conveyance means that conveys the continuous sheet, variation in the conveyance time for conveying the continuous sheet may occur due to, for example, a slip of a roller. Although the variation in the conveyance time has small influence on a short conveyance distance, the influence increases when the conveyance distance becomes longer, which may cause formation of the additional printing image on a displaced position from a desired position of the continuous sheet. In particular, an electrophotographic image forming apparatus requires a long preparation time for stabilizing a photoconductor drum and the like; hence, increasing the conveyance distance to match this preparation time causes the additional printing image to be more likely formed on the displaced position from the desired position of the continuous sheet.

### SUMMARY

An object of the present invention is to provide an image forming control apparatus and an image forming apparatus capable of suppressing wear of components related the image forming processing and preventing positional displacement of an image forming position.

To achieve at least one of the abovementioned objects, according to an aspect of the present invention, an image forming control apparatus reflecting one aspect of the present invention includes:

a first detection section that detects an image for detection formed on a recording medium;

a second detection section that detects the image for detection formed on the recording medium on a further downstream side than the first detector in a conveyance direction of the recording medium; and

a hardware processor that controls an image forming apparatus such that the image forming apparatus starts a preparation operation of image forming processing after detection in the first detection section and form an image for printing on the recording medium based on detection timing in the second detection section.

To achieve at least one of the abovementioned objects, according to another aspect of the present invention, an image forming apparatus reflecting one aspect of the present invention includes:

the image forming control apparatus; and

an image forming section that forms an image for printing on a recording medium based on a control of the image forming control apparatus.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 schematically illustrates an entire configuration of an image forming apparatus according to an embodiment of the present invention;

FIG. 2 is a block diagram illustrating main sections of a control system of the image forming apparatus according to the embodiment of the present invention;

FIG. 3 is a time chart for describing an exemplary operation at the time of image forming in the image forming apparatus according to the embodiment of the present invention;

FIG. 4A illustrates a position adjustment section that is a modification (first modification) in the image forming apparatus according to the embodiment of the present invention;

FIG. 4B is a perspective view of the position adjustment section illustrated in FIG. 4A;

FIG. 5 illustrates a position adjustment section that is a modification (second modification) in the image forming apparatus according to the embodiment of the present invention;

FIG. 6A describes a modification (third modification) in the image forming apparatus according to the embodiment of the present invention, and illustrates a case where positions of detection ranges of an upstream side detection section and a downstream side detection section are normal;

FIG. 6B describes the modification (third modification) in the image forming apparatus according to the embodiment of the present invention, and illustrates a case where the positions of detection ranges of the upstream side detection section and the downstream side detection section are abnormal;

FIG. 7 describes a modification (fourth modification) in the image forming apparatus according to the embodiment of the present invention, and is a time chart describing an exemplary operation at the time of image forming;

FIG. 8 describes a modification (fifth modification) in the image forming apparatus according to the embodiment of the present invention, and is a time chart describing an exemplary operation at the time of image forming; and

FIG. 9 describes a modification (sixth modification) in the image forming apparatus according to the embodiment of the present invention, and is a time chart describing an exemplary operation at the time of image forming.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, an embodiment of the present invention will be described in detail with reference to the accompanying drawings.

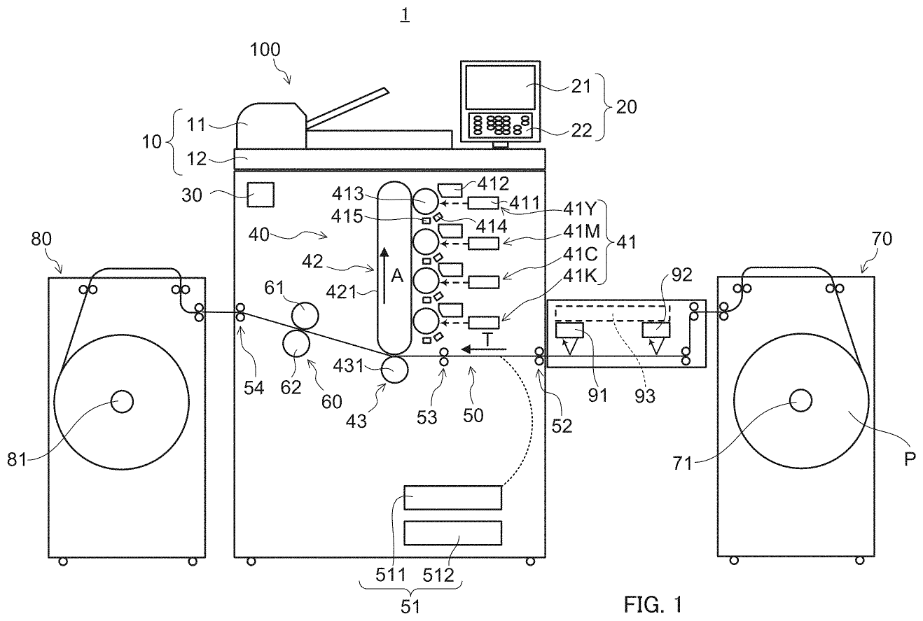

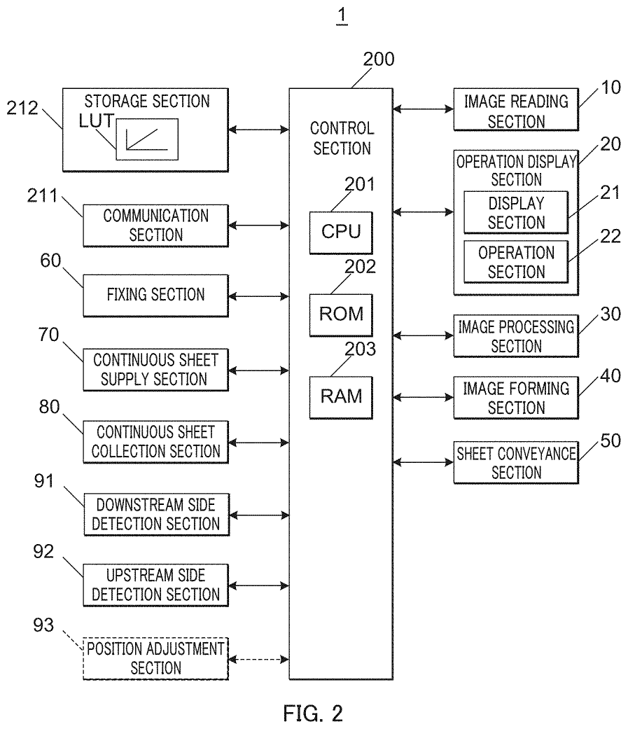

FIG. 1 schematically illustrates an entire configuration of image forming apparatus 1 according to the present embodiment. FIG. 2 is a block diagram illustrating main sections of a control system of image forming apparatus 1 according to the present embodiment.

Image forming apparatus 1 can form an image on a recording medium not only a sheet of paper (may be referred to as a “paper sheet,” hereinafter) but continuous sheet P (e.g., a roll sheet or a long sheet) and/or the like. Thus, image forming apparatus 1 includes, as illustrated in FIG. 1, image forming apparatus main body 100, continuous sheet supply section 70, and continuous sheet collection section 80. Continuous sheet supply section 70 feeds continuous sheet P, and continuous sheet collection section 80 collects continuous sheet P.

Image forming apparatus main body 100 is a color image forming apparatus of an intermediate transfer system type utilizing electrophotographic process technology. That is, image forming apparatus main body 100 primary-transfers toner images of respective colors of CMYK formed on photoconductor drums onto an intermediate transfer body, superimposes the toner images of the four colors on one another on the intermediate transfer body, and then secondary-transfers the toner images to a sheet of paper or continuous sheet P to thereby form a toner image. Note that, CMYK means cyan (C), magenta (M), yellow (Y), and black (K), respectively.

Image forming apparatus main body 100 adopts a tandem method in which the photoconductor drums corresponding to the four colors of CMYK are disposed in series in the traveling direction of the intermediate transfer body, and the toner images of the respective colors are sequentially transferred onto the intermediate transfer body through one procedure.

As illustrated in FIG. 2, image forming apparatus 1 includes image reading section 10, operation display section 20, image processing section 30, image forming section 40, sheet conveying section 50, fixing section 60, continuous sheet supply section 70, continuous sheet collection section 80, control section 200, communication section 211, storage section 212, and the like. Image forming apparatus 1 further includes downstream side detection section 91 (second detection section), upstream side detection section 92 (first detection section), position adjustment section 93 (movement section), and the like.

Control section 200 (a hardware processor) includes Central Processing Unit (CPU) 201, Read Only Memory (ROM) 202, Random Access Memory (RAM) 203, and the like. CPU 201 reads a program corresponding to processing contents from ROM 202 and loads the program into RAM 203, and controls operation of each block of image forming apparatus 1 in a centralized manner in cooperation with the loaded program. At this time, various kinds of data such as a Look Up Table (LUT) stored in storage section 212 are referred to. Storage section 212 is configured of, for example, a non-volatile semiconductor memory (so-called flash memory) or a hard disk drive.

Control section 200 transmits and receives various kinds of data to and from an external device (for example, a personal computer) connected to a communication network such as a Local Area Network (LAN) and a Wide Area Network (WAN) via communication section 211. For example, control section 200 receives image data transmitted from the external device, and forms an image on a sheet on the basis of the image data (input image data). Communication section 211 is configured of, for example, a communication control card such as a LAN card.

Image reading section 10, operation display section 20, image processing section 30, image forming section 40, sheet conveying section 50, fixing section 60, continuous sheet supply section 70, continuous sheet collection section 80, communication section 211, and storage section 212 are connected to control section 200. Further, downstream side detection section 91, upstream side detection section 92, and position adjustment section 93 are also connected to control section 200. These sections perform predetermined processing based on an instruction of control section 200.

As illustrated in FIG. 1, image reading section 10 includes automatic document feeding device 11 also called as an Auto Document Feeder (ADF), document image scanning device 12 (scanner), and the like.

Automatic document feeding device 11 conveys a document placed on a document tray by a conveying mechanism, and sends out the document to document image scanning device 12. Automatic document feeding device 11 can continuously read at once images (including those on both sides) of a large number of documents placed on the document tray.

Document image scanning device 12 optically scans a document conveyed from automatic document feeding device 11 onto a contact glass or a document placed on the contact glass, forms an image of light reflected from the document on a Charge Coupled Device (CCD) sensor to thereby read the document image. Image reading section 10 generates input image data based on a result of the reading provided by document image scanning device 12. On the input image data, predetermined image processing is performed by image processing section 30.

Operation display section 20 is configured of, for example, a Liquid Crystal Display (LCD) with a touchscreen, and functions as display section 21 and operation section 22. Display section 21 displays various operation screens, image statuses, operation conditions of each function, and the like in accordance with display control signals input from control section 200. Operation section 22 includes various operation keys such as a numeric key and a start key, receives various input operations performed by a user, and outputs operation signals to control section 200.

Image processing section 30 includes, for example, a circuit that performs digital image processing in accordance with an initial setting or a user setting on the input image data Image forming section 40 is controlled based on the processed input image data.

Image forming section 40 includes image forming unit 41, intermediate transfer unit 42, secondary transfer unit 43, and the like. Based on the input image data from image processing section 30, image forming unit 41Y forms an image of color toner of a Y component. Similarly, image forming unit 41M forms an image of color toner of an M component, image forming unit 41C forms an image of color toner of a C component, and image forming unit 41K forms an image of color toner of a K component.

Image forming units 41Y, 41M, 41C, and 41K have similar configurations. Specifically, image forming units 41Y, 41M, 41C, and 41K each include exposing device 411, developing device 412, photoconductor drum 413, charging device 414, drum cleaning device 415, and the like. Note that, in FIG. 1, reference signs of the exposing device, the developing device, the photoconductor drum, the charging device, and the drum cleaning device are omitted in image forming units 41M, 41C, and 41K. In addition, since publicly known technology can be adopted in exposing device 411, developing device 412, photoconductor drum 413, charging device 414, and drum cleaning device 415, the detailed description thereof is omitted here.

Intermediate transfer unit 42 includes intermediate transfer belt 421 and the like. Intermediate transfer belt 421 is suspended like a loop in a tensioned state on a plurality of support rollers (not illustrated) and runs in arrow A direction. The support rollers includes, for example, a backup roller, a secondary transfer roller, a driving roller; however, they are not illustrated here. Intermediate transfer belt 421 is in pressure contact with photoconductor drum 413, and thereby, the toner image is transferred from photoconductor drum 413 to intermediate transfer belt 421.

Meanwhile, intermediate transfer unit 42 may be configured to include a belt cleaning device having, for example, a plate-like belt cleaning blade which slidably contacts with the surface of intermediate transfer belt 421. The belt cleaning device removes transfer residual toner remaining on the surface of intermediate transfer belt 421 after the second transfer.

Secondary transfer unit 43 includes secondary transfer roller 431 and the like. Secondary transfer roller 431 is in pressure contact with intermediate transfer belt 421, and thereby, a secondary transfer nip is formed between intermediate transfer belt 421 and secondary transfer roller 431.

In secondary transfer unit 43, when a sheet of paper or continuous sheet P is conveyed to the secondary transfer nip, the toner images of the colors carried on intermediate transfer belt 421 are collectively transferred to the paper sheet or continuous sheet P. The sheet of paper or continuous sheet P on which the toner images are transferred is conveyed to fixing section 60 by secondary transfer roller 431.

Note that, secondary transfer unit 43 may be a belt type secondary transfer unit having, for example, a secondary transfer belt which is suspended in a tensioned state on a plurality of support rollers instead of a roller type secondary transfer unit having secondary transfer roller 431 and the like.

Sheet conveying section 50 includes paper sheet feeding section 51, sheet conveying section 52, conveyance path section 53, sheet ejection conveying section 54, and the like. Paper sheet feeding section 51 includes a plurality of sheet feed trays, for example, sheet feed trays 511 and 512. Respective sheet feed trays 511 and 512 store each preset kind of paper sheets (standard-sized sheets or special-sized sheets) identified based on basis weight or a size.

The paper sheets stored in sheet feed trays 511 and 512 are sent out one by one from the uppermost part, and conveyed to image forming section 40 by conveyance path section 53. The paper sheet on which an image is formed through image forming section 40 and fixing section 60 is ejected to the outside of the apparatus by sheet ejection conveying section 54.

Sheet conveying section 52, conveyance path section 53, and sheet ejection conveying section 54 are configured of, for example, a plurality of conveyance rollers and a driving motor that rotationally drives the conveyance rollers. Sheet conveying section 52 conveys continuous sheet P sent out from continuous sheet supply section 70 to conveyance path section 53. Conveyance path section 53 conveys the paper sheet or continuous sheet P to image forming section 40. Sheet ejection conveying section 54 conveys the paper sheet or continuous sheet P subjected to fixing processing at fixing section 60, in a case of continuous sheet P, conveys continuous sheet P to continuous sheet collection section 80.

Fixing section 60 includes fixing roller 61, pressure roller 62, and the like. Fixing roller 61 is heated to a predetermined fixing temperature, pressure roller 62 forms a fixing nip which holds and conveys the paper sheet or continuous sheet P in between with fixing roller 61. This fixing section 60 fixes a toner image to the paper sheet or continuous sheet P by heating and pressurizing, using the fixing nip, the conveyed paper sheet or continuous sheet P on which the toner image has been secondary transferred.

Continuous sheet supply section 70 is placed on a further upstream side than image forming apparatus main body 100 in conveyance direction T conveying continuous sheet P. and includes mounting section 71 having a supporting shaft. Mounting section 71 rotatably supports wound continuous sheet P, sends out and feeds continuous sheet P to sheet conveying section 52 of image forming apparatus main body 100 based on a start instruction of image forming processing

Continuous sheet collection section 80 is placed on a further downstream side than image forming apparatus main body 100 in conveyance direction T, and includes winding section 81 having a supporting shaft. Winding section 81 collects continuous sheet P discharged from sheet ejection conveying section 54 of image forming apparatus main body 100, by winding continuous sheet P around the supporting shaft. Note that, continuous sheet P is not always required to be rolled up, and may be cut and stored by each page.

Between continuous sheet supply section 70 and image forming apparatus main body 100, downstream side detection section 91 is placed, which detects an image for detection previously formed on continuous sheet P. A line sensor or a camera is usable as downstream side detection section 91 as long as it can detect the image for detection, such as an eye mark.

Although a description will be given later of detailed processing in which downstream side detection section 91 detects the image for detection, control section 200 (see FIG. 2) causes image forming section 40 to start the image forming processing based on a timing when downstream side detection section 91 detects the image for detection. Thus, a position for image forming is fixed, and an image for printing can be formed on a desired position of continuous sheet P. For example, in a case of additional printing, the image for printing serving as an additional printing image can be formed on a position matching the image that has been preliminarily printed on continuous sheet P (hereinafter, a “preliminary image”).

Incidentally, in image forming apparatus 1, taking into consideration a preparation time until a stable operation of a component of image forming section 40, downstream side detection section 91 may be moved to increase a conveyance distance of the continuous sheet between downstream side detection section 91 and image forming section 40. However, in this case, due to variation in the conveyance time for conveying continuous sheet P, an image for printing such as an additional printing image is more likely to be formed on a displaced position from a desired position of continuous sheet P.

Accordingly, in the present embodiment, image forming apparatus 1 includes, on a further upstream side than downstream side detection section 91 in conveyance direction T, upstream side detection section 92 that detects the image for detection formed on continuous sheet P. Although a description will be also given later of detailed processing in which upstream side detection section 92 detects the image for detection, a preparation operation of the image forming processing is started after upstream side detection section 92 detects the image for detection so that the component related to the image forming processing can be stabilized.

Similarly to downstream side detection section 91, a line sensor or a camera is usable as upstream side detection section 92 as long as it can detect the image for detection.

Downstream side detection section 91 desirably has high accuracy in temporal detection because its detection serves as a trigger of a timing to start the image forming processing, and variation in its detection timing affects an image forming position in continuous sheet P. Thus, downstream side detection section 91 desirably has high temporal resolution that is a time interval required for the detection, compared with upstream side detection section 92. For example, downstream side detection section 91 preferably has a short sampling interval for the detection because the temporal resolution becomes high. Further, in a case where, for example, a camera is used as downstream side detection section 91, the camera preferably has a large number of pixels because the sampling intervals between adjacent pixels become short, and the temporal resolution becomes high.

On the other hand, upstream side detection section 92 is not required to have the high accuracy in temporal detection because its detection serves as a trigger of a timing to start the preparation operation of the image forming processing, and variation in its detection timing has small influence on the preparation operation. Hence, upstream side detection section 92 may be inexpensive with the low temporal resolution. Thus, upstream side detection section 92 may have the low temporal resolution, but desirably has a wide detection range capable of detecting the image for detection so as to allow detection of the image for detection any where on continuous sheet P.

Besides, upstream side detection section 92 may be, for example, a camera or a barcode reader which is detectable image information on the image for detection as well as the presence or absence of the image for detection. In this case, a QR code (registered trademark), a barcode, a number, a letter, or the like may be used as the image for detection. That is, upstream side detection section 92 may detect a different image for detection from downstream side detection section 91.

By way of example, in a case where upstream side detection section 92 is a camera, and the image for detection is a QR code, the QR code is formed so as to include sheet information (e.g., thickness, basis weight, length or width of continuous sheet P) and printing information (e.g., information on the image for printing, or the number of copies). Further, in a case where upstream side detection section 92 is a barcode reader, and the image for detection is a barcode, the barcode is formed so as to include the above sheet information and printing information.

Control section 200 then performs the preparation operation of the image forming processing based on the image information detected by upstream side detection section 92, that is, the sheet information and the printing information. For example, when the QR code or the barcode includes the information related to the image for printing, control section 200 performs the preparation operation by causing image processing section 30 to perform the image processing for preparation of the image for printing, based on the information.

Although downstream side detection section 91 and upstream side detection section 92 usually detect the same image for detection, as described above, they may respectively detect different images for detection. In a case where downstream side detection section 91 and upstream side detection section 92 detect the same image for detection, images for detection respectively corresponding to downstream side detection section 91 and upstream side detection section 92 need not be set, which leads to improved efficiencies of a printing operation.

Besides, in conveyance orthogonal direction C that is orthogonal to conveyance direction T, downstream side detection section 91 and upstream side detection section 92 are arranged so that the image for detection passes a detection range of downstream side detection section 91 and upstream side detection section 92. As described above, in a case where downstream side detection section 91 and up stream side detection section 92 detect the same image for detection, downstream side detection section 91 and upstream side detection section 92 are arranged on the same line along conveyance direction T.

Further, upstream side detection section 92 may be placed on any position as long as the position is on a further upstream side than downstream side detection section 91 in conveyance direction T, and, in the position, enough time can be secured to complete the preparation operation of the image forming processing. For example, in FIG. 1, upstream side detection section 92 is placed between continuous sheet supply section 70 and downstream side detection section 91, but it may be placed in continuous sheet supply section 70.

Meanwhile, downstream side detection section 91 is placed on a position which is on a further downstream side than upstream side detection section 92 in conveyance direction T, and at which the image forming processing is started in image forming section 40. That is, downstream side detection section 91 need not be placed on a remote position from image forming section 40, unlike upstream side detection section 92.

Here, a preparation operation of image forming processing will be described.

Image forming section 40 starts the preparation operation of the image forming processing at the timing, as a trigger, when upstream side detection section 92 detects the image for detection (the upstream detection timing). At this time, the preparation operation may be started in all devices configuring image forming section 40, or in apart of the devices. When the preparation operation of a part of the devices is started, a device other than the device that starts the preparation operation may start the preparation operation at a different timing from the upstream detection timing. For example, some electric apparatuses become operable immediately after energization, and thus such electric apparatuses may start the preparation operation at a timing later than the upstream detection timing. Further, as described below, as a part related to the image forming processing, image processing section 30, fixing section 60, and devices configuring them may start the preparation operation as well as image forming section 40.

For example, a device which has stopped its operation in consideration of wear of parts corresponds to the device that starts the preparation operation at the upstream detection timing. In one example, a motor that drives rotors such as a polygon mirror of exposing device 411, photoconductor drum 413, intermediate transfer belt 421, fixing roller 61 of fixing section 60 and pressure roller 62, and a fan, for example, are subject to the preparation operation, and the preparation operation is started by starting its rotation. In addition, devices that perform a pressure contact/separation operation such as a secondary transfer roller of intermediate transfer unit 42, secondary transfer roller 431 of secondary transfer unit 43, fixing roller 61 and pressure roller 62 of fixing section 60, and the like are also subject to the preparation operation, and the preparation operation is started by performing the pressure contact/separation operation.

Further, as another example, a device which has been turned off in consideration of wear of parts may be subjected to the preparation operation, as well as the device that performs a physical operation. For example, the device can be put in a state capable of controlling the image forming processing by starting energization to an electrode such as a charging electrode and decharging electrode, or causing a CPU controlling image processing section 30, image forming section 40, and fixing section 60 to transition from a sleep state to an idle state

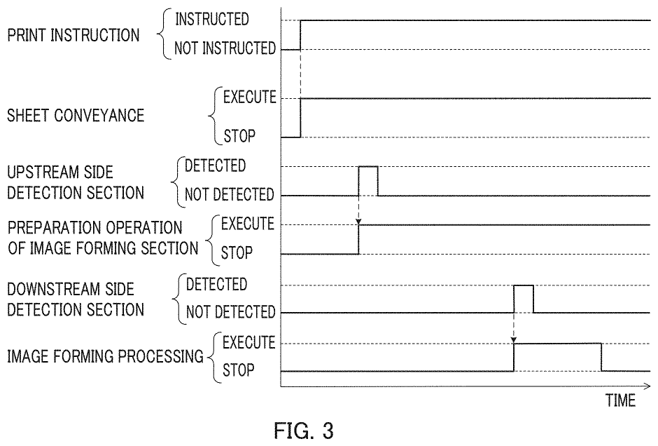

Next, a description will be given of image forming processing performed in image forming apparatus 1 including above-described downstream side detection section 91 and upstream side detection section 92 with reference to FIG. 3 in addition to FIGS. 1 and 2. FIG. 3 is a time chart illustrating an exemplary operation at the time of image forming in image forming apparatus 1.

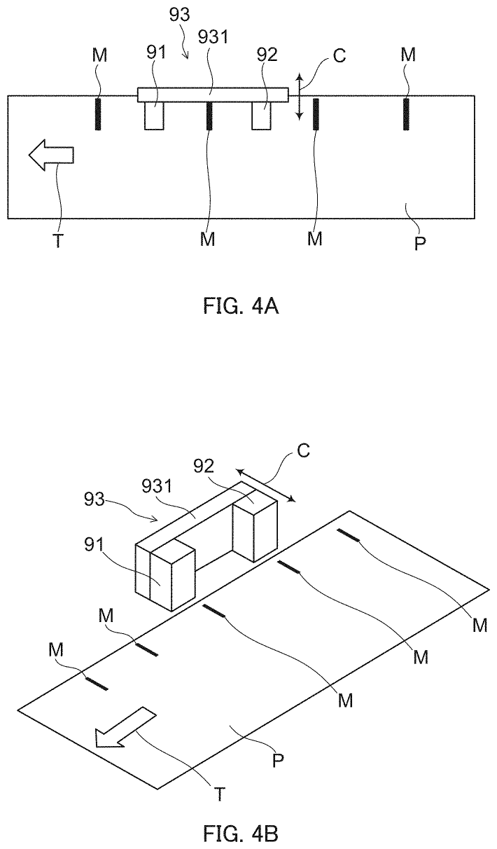

Prior to the image forming processing to be described below, a preliminary image and an image for detection are preliminarily formed on continuous sheet P. As the image for detection, for example, eye marks of black squares are formed as illustrated in FIG. 4A described later.

Continuous sheet P on which the preliminary image and the eye marks are preliminarily formed is mounted on mounting section 71 of continuous sheet supply section 70. After that, in operation section 22 of operation display section 20, a print instruction is input to control section 200 of image forming apparatus 1 by, for example, a user pressing a start button.

When the print instruction is input, control section 200 instructs sheet conveying section 50, continuous sheet supply section 70, and continuous sheet collection section 80 to perform sheet conveyance, and thus, sheet conveyance of continuous sheet P is started.

After the sheet conveyance of continuous sheet P starts, upstream side detection section 92 firstly detects an eye mark. Control section 200 causes image processing section 30, image forming section 40, and fixing section 60 to start the above-described preparation operation of the image forming processing at the upstream detection timing at upstream side detection section 92, as a trigger.

After upstream side detection section 92 detects the eye mark, downstream side detection section 91 detects the eye mar. Control section 200 causes image forming section 40 to start the image forming processing at the timing, as a trigger, when downstream side detection section 91 detects the eye mark (the downstream detection timing).

As described above, upstream side detection section 92 is placed on a position where the time to complete the preparation operation of the image forming processing in image forming section 40 and the like can be secured, and image forming section 40 and the like start the preparation operation of the image forming processing at the upstream detection timing as a trigger. Thus, when image forming section 40 and the like starts the image forming processing at the downstream detection timing, as a trigger, for example, the rotation of photoconductor drum 413 is in a stable state, and image forming processing can be executed without any problems.

In addition, downstream side detection section 91 is placed on a position serving as a timing when image forming section 40 starts the image forming processing; therefore, downstream side detection section 91 need not be placed on a remote position from image forming section 40, unlike upstream side detection section 92. Thus, when image forming section 40 starts the image forming processing at the downstream detection timing as a trigger, a position for image forming is fixed, which enables forming an image on a desired position of continuous sheet P. For example, in a case of additional printing, an additional printing image can be formed on a position matching a preliminary image that has been preliminarily formed.

As described above, image forming apparatus 1 of the present embodiment includes upstream side detection section 92 that detects the image for detection formed on continuous sheet P and downstream side detection section 91 that detects the image for detection formed on continuous sheet P on a further downstream side than upstream side detection section 92 in conveyance direction T. In addition, image forming apparatus 1 of the present embodiment includes control section 200 that starts the preparation operation of the image forming processing after the detection at upstream side detection section 92, and controls to form the image for printing on continuous sheet P based on the downstream detection timing at downstream side detection section 91.

According to image forming apparatus 1 of the present embodiment having such a configuration, since the preparation operation of the image forming processing starts after the detection in upstream side detection section 92, parts need not be always in a drive state, and thus, wear of the parts related to the image forming processing can be suppressed. In addition, the image for printing is formed on continuous sheet P based on the detection timing at downstream side detection section 91 detection timing, and downstream side detection section 91 need not be placed on the remote position from image forming section 40, which enables preventing positional displacement of the image forming position. The eye marks used as the images for detection are often periodically formed on continuous sheet P; however, in the present embodiment, the above effect can be obtained even when the eye marks are non-periodically formed on continuous sheet P.

(First Modification)

Image forming apparatus 1 described above may have a configuration in which downstream side detection section 91 and upstream side detection section 92 are positionally adjustable by moving in conveyance orthogonal direction C in conjunction with each other. A description will be given of position adjustment section 93 that performs such position adjustment with reference to FIGS. 4A and 4B in addition to FIGS. 1 and 2.

FIG. 4A illustrates position adjustment section 93. FIG. 4B is a perspective view of position adjustment section 93 illustrated in FIG. 4A.

Position adjustment section 93 includes stationary plate 931 and the like. In a case where a distance between downstream side detection section 91 and upstream side detection section 92 can be fixed by one stationary plate 931, downstream side detection section 91 and upstream side detection section 92 are fixed on the same surface of the same stationary plate 931. This stationary plate 931 is placed so that its longitudinal direction is conveyance direction T. Thus, downstream side detection section 91 and upstream side detection section 92 are arranged in the same line along conveyance direction T. Accordingly, stationary plate 931, for example, can be manually moved in conveyance orthogonal direction C by using a driving mechanism (not illustrated). Note that, the driving mechanism may be driven under the control of control section 200.

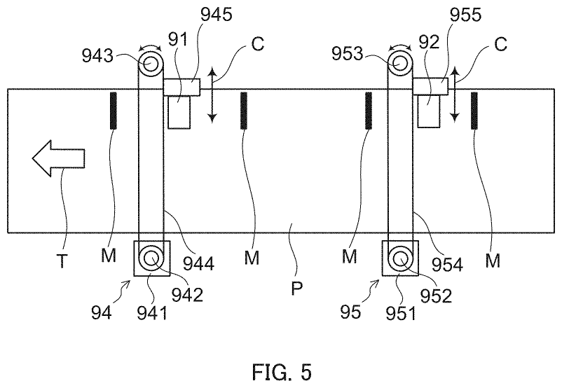

Besides, as illustrated in FIGS. 4A and 4B, eye marks M of black squares are preliminarily formed on continuous sheet P as an exemplary image for detection. Eye marks M are placed on the same line along conveyance direction T of a side end section forming a partial area of continuous sheet P (a right side section facing the downstream side of conveyance direction T). Placement of eye marks M is similar in later described FIGS. 5,6A, and 6B.

Thus, by moving stationary plate 931 in conveyance orthogonal direction C using the driving mechanism, downstream side detection section 91 and upstream side detection section 92 are moved in conveyance orthogonal direction C in conjunction with each other to adjust their positions. This adjustment enables downstream side detection section 91 and upstream side detection section 92 to detect the same eye mark M.

As described above, image forming apparatus 1 of the present modification includes position adjustment section 93 which moves downstream side detection section 91 and upstream side detection section 92 in conveyance orthogonal direction C in conjunction with each other.

According to the present modification having such configuration, downstream side detection section 91 and upstream side detection section 92 are positionally adjusted in conjunction with each other by position adjustment section 93, and thus, the same eye mark M can be reliably detected.

(Second Modification)

In above-described image forming apparatus 1, instead of position adjustment section 93 illustrated in FIGS. 4A and 4B, position adjustment sections 94 and 95 (movement section) illustrated in FIG. 5 may be used. FIG. 5 illustrates position adjustment sections 94 and 95.

Position adjustment section 94 includes motor 941, rollers 942 and 943, belt 944, support plate 945, and the like. Motor 941 rotationally drives roller 942 under the control of control section 200. Roller 942 and roller 943 are arranged opposite to each other across continuous sheet P in conveyance orthogonal direction C. Belt 944 is suspended like a loop in a tensioned state on rollers 942 and 943. Support plate 945 is supported by belt 944, while downstream side detection section 91 is supported by support plate 945.

Position adjustment section 95 has a similar configuration with position adjustment section 94 and includes motor 951, rollers 952 and 953, belt 954, support plate 955, and the like. Motor 951 rotationally drives roller 952 under the control of control section 200. Rollers 952 and roller 953 are arranged opposite to each other across continuous sheet P in conveyance orthogonal direction C. Belt 954 is suspended like a loop in a tensioned state on roller 952 and 953. Support plate 955 is supported by belt 954, while upstream side detection section 92 is supported by support plate 955.

In a case where downstream side detection section 91 and upstream side detection section 92 cannot be fixed by above-described one stationary plate 931 because, for example, a distance between them is large, the configuration using position adjustment sections 94 and 95, illustrated in FIG. 5 is suitable.

Motor 941 is driven by the control of control section 200, and thereby roller 942 is rotationally driven, so that belt 944 travels around orbits between roller 942 and roller 943, and thus, support plate 945 moves in conveyance orthogonal direction C. Similarly, motor 951 is driven by the control of control section 200, and thereby roller 952 is rotationally driven, so that belt 954 travels around roller 952 and roller 953, and thus, support plate 955 moves in conveyance orthogonal direction C.

When support plate 945 is moved, support plate 955 is also moved in conjunction with this so that downstream side detection section 91 supported by support plate 945 and upstream side detection section 92 supported by support plate 955 are arranged in the same line along conveyance direction T, and these sections are positionally adjusted in such a manner. This enables downstream side detection section 91 and upstream side detection section 92 to detect the same eye mark M.

As above, downstream side detection section 91 and upstream side detection section 92 can be moved in conjunction with each other in conveyance orthogonal direction C, which allows adjusting their positions so that eye mark M passes the detection ranges thereof. Note that, when adjusting positions, the positions may be adjusted so that at least a part of eye mark M passes the detection ranges of downstream side detection section 91 and upstream side detection section 92.

As described above, image forming apparatus 1 of the present modification includes position adjustment sections 94 and 95 which move downstream side detection section 91 and upstream side detection section 92 in conjunction with each other in conveyance orthogonal direction C.

According to the present modification having such configuration, downstream side detection section 91 and upstream side detection section 92 are positionally adjusted in conjunction with each other by position adjustment sections 94 and 95, and thus, the same eye mark M can be reliably detected.

(Third Modification)

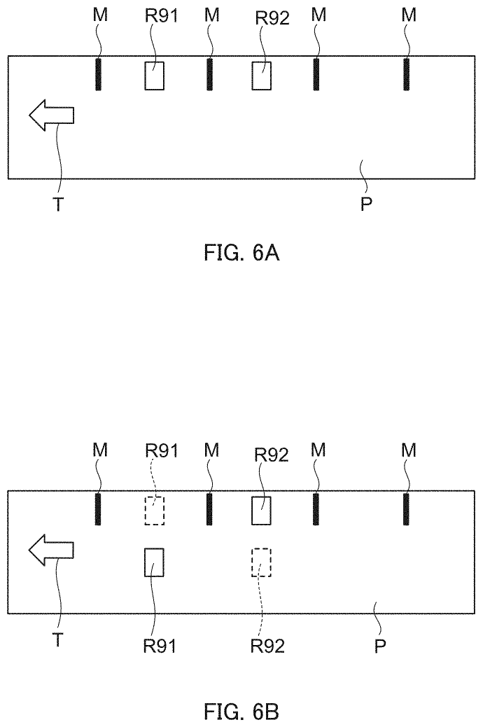

In image forming apparatus 1 described above, a failure may occur in downstream side detection section 91 and upstream side detection section 92. Further, for example, in the second modification described above, a position adjustment of downstream side detection section 91 and upstream side detection section 92 may not be normally performed due to a failure in position adjustment sections 94 and 95 or the like. A description will be given of cases where such failures occur with reference to FIGS. 6A and 6B in addition to FIG. 5.

FIG. 6A illustrates a case where positions of detection ranges R91 and R92 of upstream side detection section 92 and downstream side detection section 91 are normal. FIG. 6B illustrates a case where the positions of detection ranges R91 and R92 of upstream side detection section 92 and downstream side detection section 91 are abnormal.

As illustrated in FIG. 5, positions of downstream side detection section 91 and upstream side detection section 92 are adjusted so that, as illustrated in FIG. 6A, eye mark M passes their detection ranges R91 and R92. When the positions of downstream side detection section 91 and upstream side detection section 92 are correctly adjusted, as illustrated in FIG. 6A, eye mark M passes detection ranges R91 and R92. Thus, downstream side detection section 91 and upstream side detection section 92 individually detects the same eye mark M to obtain the downstream detection timing and the upstream detection timing.

On the other hand, when the positions of downstream side detection section 91 and upstream side detection section 92 are not correctly adjusted, for example, as illustrated in FIG. 6B by a solid line, eye mark M passes detection range R92 but may not pass detection range R91 (a first error). In addition, as illustrated in FIG. 6B by a dotted line, eye mark M passes detection range R91 but may not pass detection range R92 (a second error).

The above first error will be described. When a failure or a positional displacement occurs in downstream side detection section 91, the first error occurs. In this case, control section 200 determines that the first error has occurred in a case where downstream side detection section 91 does not detect eye mark M within a predetermined time after upstream side detection section 92 detects eye mark M, and thus stops forming processing of the image for printing.

Here, control section 200 can obtain a detection section conveyance time for conveying continuous sheet P from upstream side detection section 92 to downstream side detection section 91 because control section 200 can grasp the sheet conveyance speed of continuous sheet P. and thereby uses the detection section conveyance time as the above predetermined time. For example, control section 200 may determine whether downstream side detection section 91 has detected or not eye mark M within the predetermined time by using a timer with the predetermined time.

The above second error will be described. When a failure or a positional displacement occur in upstream side detection section 92, the second error occurs. In this case, control section 200 determines that the second error has occurred in a case where upstream side detection section 92 does not detect eye mark M, whereas downstream side detection section 91 detects eye mark M, and thus stops the forming processing of the image for printing.

Note that, although not illustrated, an error may occur in which eye mark M does not pass neither detection range R91 nor detection range R92. In some cases, control section 200 can predict the time when eye mark M passes detection range R91 and detection range R92 after the conveyance of continuous sheet P is started. In this case, control section 200 may stop the forming processing of the image for printing when eye mark M is not detected in upstream side detection section 92 and downstream side detection section 91 even after a lapse of the time in which eye mark M is predicted to pass detection range R91 and detection range R92.

In any case of these errors, control section 200 stops the forming processing of the image for printing, but also stops the conveyance of continuous sheet P to be performed by sheet conveying section 50, continuous sheet supply section 70, and continuous sheet collection section 80, and causes display section 21 of operation display section 20 to display a message. In a case where the message is displayed on display section 21, for example, the message asking a user to check the positions of downstream side detection section 91 and upstream side detection section 92 may be displayed.

As described above, in image forming apparatus 1 of the present modification, control section 200 stops the forming processing of the image for printing in a case where downstream side detection section 91 does not detect eye mark M within the predetermined time after upstream side detection section 92 detects eye mark M. In addition, control section 200 stops the forming processing of the image for printing in a case where upstream side detection section 92 does not detect eye mark M, whereas downstream side detection section 91 detects eye mark M.

According to the present modification having such configuration, the forming processing of the image for printing is stopped in accordance with the detection state of eye mark M in downstream side detection section 91 and upstream side detection section 92. Thus, a printing error can be prevented by detecting failure in downstream side detection section 91 and upstream side detection section 92 before printing.

(Fourth Modification)

As described above, upstream side detection section 92 is placed on any position which is on a further upstream side than downstream side detection section 91 in conveyance direction T, and at which time can be secured to complete the preparation operation of the image forming processing. However, depending on, for example, a device state or a content of the image forming processing, the preparation operation may require a long time, which results in that the preparation operation may not be performed in time.

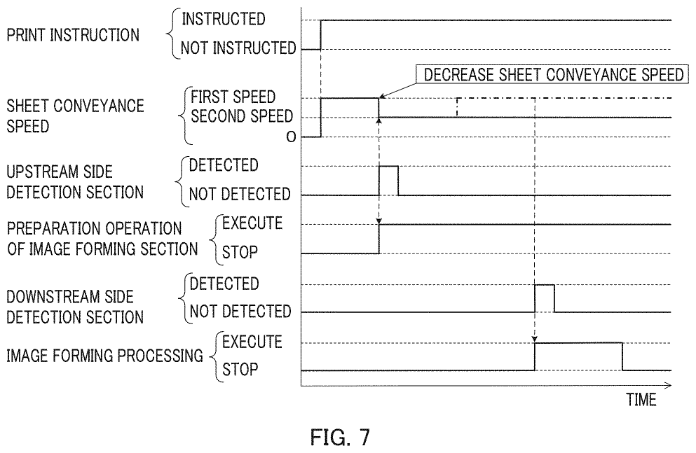

Processing for dealing with such cases will be described with reference to FIG. 7 in addition to FIGS. 1 and 2. FIG. 7 is a time chart for describing an exemplary operation of image forming in image forming apparatus 1.

As described in FIG. 3, before the image forming processing, a preliminary image and an image for detection (e.g., an eye mark) are formed on continuous sheet P.

Continuous sheet P on which the preliminary image and the eye mark are preliminarily formed is mounted on mounting section 71 of continuous sheet supply section 70. After that, in operation section 22 of operation display section 20, a print instruction is input to control section 200 of image forming apparatus 1 by, for example, a user pressing a start button.

When the print instruction is input, control section 200 instructs sheet conveying section 50, continuous sheet supply section 70, and continuous sheet collection section 80 to perform sheet conveyance, and thus, sheet conveyance of continuous sheet P is started. At this time, sheet conveying section 50, continuous sheet supply section 70, and continuous sheet collection section 80 convey continuous sheet P at a first speed (a predetermined conveyance speed). The first speed is, for example, the speed at which continuous sheet P is conveyed in a case of image forming in image forming section 40 (printing speed), but any speed may be used.

After the sheet conveyance of continuous sheet P is started, upstream side detection section 92 firstly detects an eye mark. Control section 200 causes image forming section 40 to start the preparation operation of the image forming processing at the upstream detection timing, as a trigger, when upstream side detection section 92 detects the eye mark. Although this preparation operation is as described above; here, control section 200 determines that the preparation operation of the image forming processing requires time.

Thus, as illustrated in FIG. 7, control section 200 decreases the sheet conveyance speed of continuous sheet P to a second speed slower than the first speed at the timing, as a trigger, when upstream side detection section 92 detects the eye mark, to convey continuous sheet P.

At this time, control section 200 compares a detection section conveyance time for conveying continuous sheet P from upstream side detection section 92 to downstream side detection section 91 and a completion time for completing the preparation operation of the image forming processing from its start. Control section 200 then sets the second speed so that the detection section conveyance time becomes longer than the completion time. That is, when the detection section conveyance time is longer than the completion time, the first speed is used, whereas when the detection section conveyance time is shorter than the completion time, the second speed slower than the first speed is used.

For example, a fixing temperature of fixing roller 61 of fixing section 60 may drop due to a surrounding environment and require time to rise to the fixing temperature. In such a case, control section 200 determines that the preparation operation requires time and conveys continuous sheet P by decreasing the sheet conveyance speed of continuous sheet P to the second speed, accordingly.

In addition, during printing on continuous sheet P, an adjustment mode (e.g., cleaning) for stabilizing an operation of a device in image forming section 40 or the like is executed, the preparation operation of image forming section 40 or the like may take time. In such a case, control section 200 determines that the preparation operation requires time and conveys continuous sheet P by decreasing the sheet conveyance speed of continuous sheet P to the second speed, accordingly.

After upstream side detection section 92 detects the eye mark, downstream side detection section 91 detects the eye mar. Control section 200 causes image forming section 40 to start the image forming processing at the downstream detection timing, as a trigger, when downstream side detection section 91 detects the eye mark.

As described above, the sheet conveyance speed of continuous sheet P is decreased at the upstream detection timing, as a trigger, w % ben upstream side detection section 92 detects the eye mark. This prolongs the time to convey continuous sheet P to image forming section 40 to secure the time for completing the preparation operation of the image forming processing. Thus, when image forming section 40 starts the image forming processing at the downstream detection timing as a trigger, for example, the rotation of photoconductor drum 413 is in a stable state, and image forming processing can be executed without any problems.

Besides, as illustrated in FIG. 7 by a dashed lime, the sheet conveyance speed decreased to the second speed may be restored to the first speed. This is executable in a case where the time for completing the preparation operation of the image forming processing can be secured by temporarily decreasing the sheet conveyance speed to the second speed.

In a case where the sheet conveyance speed is restored from the second speed to the first speed, it is desirable to restore to the first speed before downstream side detection section 91 detects the eye mark. Changing the sheet conveyance speed after downstream side detection section 91 detects the eye mark means that the sheet conveyance speed is changed on a conveyance path from downstream side detection section 91 to image forming section 40. In this case, the speed change in the middle of the conveyance path may cause variation in the conveyance time for conveying continuous sheet P from downstream side detection section 91 to image forming section 40. Thus, restoring to the first speed before downstream side detection section 91 detects the eye mark is desirable. Accordingly, the sheet conveyance speed need not be changed on the conveyance path from downstream side detection section 91 to image forming section 40, which can prevent an occurrence of the variation in the conveyance time for conveying continuous sheet P from downstream side detection section 91 to image forming section 40.

As described above, image forming apparatus 1 of the present modification includes control section 200 serving as a speed change section which changes the conveyance speed for conveyance of continuous sheet P before or after the detection in at least one of downstream side detection section 91 or upstream side detection section 92.

According to the present modification having such configuration, when the preparation operation requires time, the conveyance speed for conveyance of continuous sheet P is decreased, and thus, the time required for the preparation of the image forming processing operation can be reliably secured.

(Fifth Modification)

The above fourth modification is for a case where control section 200 can calculate the time required for the preparation operation of the image forming processing; however, in some cases control section 200 cannot calculate the time for the preparation operation of the image forming processing. Further, the above fourth modification secure the time required for the preparation operation of the image forming processing by decreasing the sheet conveyance speed; however, in some cases the time required for the preparation operation of the image forming processing may not be secured just by decreasing the sheet conveyance speed.

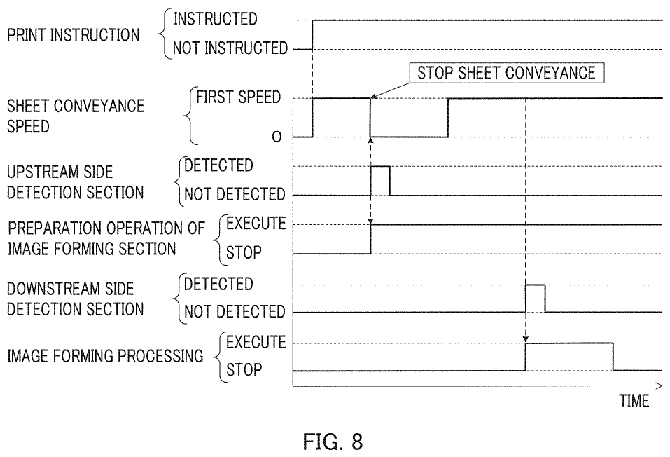

Processing for dealing with such cases will be described with reference to FIG. 8 in addition to FIGS. 1 and 2. FIG. 8 is a time chart for describing an exemplary operation of image forming in image forming apparatus 1.

As described in FIG. 3, before the image forming processing, a preliminary image and an image for detection (e.g., an eye mark) are preliminarily formed on continuous sheet P.

Continuous sheet P on which the preliminary image and the eye mark are preliminarily formed is mounted on mounting section 71 of continuous sheet supply section 70. After that, in operation section 22 of operation display section 20, a print instruction is input to control section 200 of image forming apparatus 1 by, for example, a user pressing a start button.

When the print instruction is input, control section 200 instructs sheet conveying section 50, continuous sheet supply section 70, and continuous sheet collection section 80 to perform sheet conveyance, and thus, sheet conveyance of continuous sheet P is started. At this time, sheet conveying section 50, continuous sheet supply section 70, and continuous sheet collection section 80 convey continuous sheet P at the sheet conveyance speed corresponding to the first speed.

After the sheet conveyance of continuous sheet P is started, upstream side detection section 92 firstly detects an eye mark. Control section 200 causes image forming section 40 to start the preparation operation of the image forming processing at the upstream detection timing, as a trigger, when upstream side detection section 92 detects the eye mark. Although this preparation operation is as described above; here, control section 200 determines that, for example, the time required for the preparation operation of the image forming processing is unpredictable.

Thus, as illustrated in FIG. 8, control section 200 temporarily stops the sheet conveyance of continuous sheet P at the upstream detection timing, as a trigger, when upstream side detection section 92 detects the eye mark.

At this time, control section 200 compares a detection section conveyance time for conveying continuous sheet P from upstream side detection section 92 to downstream side detection section 91 and a completion time for completing the preparation operation of the image forming processing from its start. Control section 200 then temporarily stops the sheet conveyance so that the detection section conveyance time becomes longer than the completion time. That is, when the detection section conveyance time is shorter than the completion time, the sheet conveyance is temporarily stopped.

For example, in a case where upstream side detection section 92 is a camera, an image for detection is a QR code, and the QR code includes information related to image for printing, image processing for preparing the image for printing in image processing section 30 may require time. More specifically, in image processing section 30, the image processing for preparing the image for printing takes a quite long time, or the processing time for the image processing may be unpredictable. In such cases, control section 200 temporarily stops the sheet conveyance of continuous sheet P.

Thus, in a case where the sheet conveyance of continuous sheet P is temporarily stopped, control section 200 resumes the sheet conveyance of continuous sheet P when processing requiring time for the preparation operation is completed. For example, in a case where the image processing in image processing section 30 requires time, the sheet conveyance of continuous sheet P is resumed when the image processing in image processing section 30 is completed. In this case, for example, the sheet conveyance is resumed at the sheet conveyance speed corresponding to the first speed.

After the sheet conveyance is resumed, downstream side detection section 91 detects the eye mark. Control section 200 causes image forming section 40 to start the image forming processing at the downstream detection timing, as a trigger, when downstream side detection section 91 detects the eye mark.

As described above, the sheet conveyance of continuous sheet P is temporarily stopped at the upstream detection timing, as a trigger, when upstream side detection section 92 detects the eye mark. This prolongs the time to convey continuous sheet P to image forming section 40 to secure a time for completing the preparation operation of the image forming processing. Thus, when image forming section 40 starts the image forming processing by using the downstream detection timing as a trigger, for example, the rotation of photoconductor drum 413 is in a stable state, and image forming processing can be executed without any problems.

As described above, image forming apparatus 1 of the present modification includes control section 200 serving as a speed change section which changes the conveyance speed for conveyance of continuous sheet P before or after the detection in at least one of downstream side detection section 91 or upstream side detection section 92.

According to the present modification having such configuration, when the preparation operation requires time, the conveyance of continuous sheet P is stopped until completion of the preparation operation, and thus, the time required for the preparation operation can be reliably secured.

(Sixth Modification)

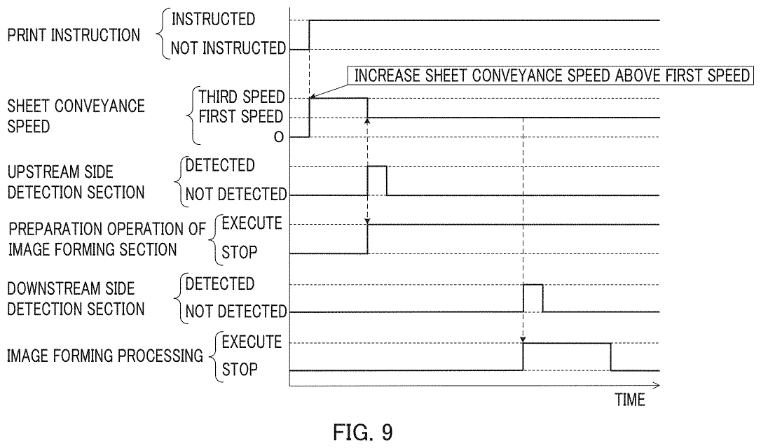

Image forming apparatus 1 described above may shorten the time required for printing by changing a conveyance speed of continuous sheet P. Processing for shortening the printing time will be described with reference to FIG. 9 in addition to FIGS. 1 and 2. FIG. 9 is a time chart for describing an exemplary operation of image forming in image forming apparatus 1.

As described in FIG. 3, before the image forming processing, a preliminary image and an image for detection (e.g., an eye mark) are preliminarily formed on continuous sheet P.

Continuous sheet P on which the preliminary image and the eye mark are preliminarily formed is mounted on mounting section 71 of continuous sheet supply section 70. After that, in operation section 22 of operation display section 20, a print instruction is input to control section 200 of image forming apparatus 1 by, for example, a user pressing a start button.

When the print instruction is input, control section 200 instructs sheet conveying section 50, continuous sheet supply section 70, and continuous sheet collection section 80 to perform sheet conveyance, and thus, sheet conveyance of continuous sheet P is started. At this time, sheet conveying section 50, continuous sheet supply section 70, and continuous sheet collection section 80 convey continuous sheet P at a third speed that is a sheet conveyance speed faster than the first speed.

The conveyance speed of continuous sheet P has no limitation until upstream side detection section 92 detects the eye mark. Thus, the sheet conveyance time of continuous sheet P is shortened by conveying continuous sheet P at the third speed faster than first speed until the upstream side detection section 92 detects the eye mark, and thus, the time required for printing in continuous sheet P can be shortened.

After the sheet conveyance of continuous sheet P is started at the third speed, upstream side detection section 92 firstly detects an eye mark. Control section 200 causes image forming section 40 to start the preparation operation of the image forming processing at the upstream detection timing, as a trigger, when upstream side detection section 92 detects the eye mark. This preparation operation is as described above.

In addition, as illustrated in FIG. 9, control section 200 restores the sheet conveyance speed of continuous sheet P to the first speed and conveys continuous sheet P at the upstream detection timing, as a trigger, when upstream side detection section 92 detects the eye mark. Note that, with respect to the timing for restoring the sheet conveyance speed of continuous sheet P to the first speed, any timing is acceptable as long as the timing is after the detection in upstream side detection section 92 and before the detection in downstream side detection section 91.

After upstream side detection section 92 detects the eye mark, downstream side detection section 91 detects the eye mark. Control section 200 causes image forming section 40 to start the image forming processing at the downstream detection timing, as a trigger, when downstream side detection section 91 detects the eye mark.

As described above, image forming apparatus 1 of the present modification includes control section 200 serving as a speed change section which changes the conveyance speed for conveyance of continuous sheet P before or after the detection in at least one of downstream side detection section 91 or upstream side detection section 92.

According to the present modification having such configuration, continuous sheet P is conveyed at the third speed faster than first speed until the upstream side detection section 92 detects the eye mark, and thus, the time required for printing in continuous sheet P can be shortened.

### Other Embodiments

In the above embodiments and the modifications, control section 200 of image forming apparatus 1 controls image forming section 40 and/or the like based on the detections in downstream side detection section 91 and upstream side detection section 92; however, these components may be configured as an independent apparatus. That is, an image forming control apparatus may be configured to include downstream side detection section 91, upstream side detection section 92, and a control section that controls image forming apparatus 1 based on the detections in them.

In the above embodiments and the modifications, the additional printing on continuous sheet P is exemplified; however, a sheet other than continuous sheet P or a printing method other than the additional printing may be applicable as long as the printing method performs printing by detecting an image for detection such as an eye mark.

In the above embodiments and the modifications, an adjustment device (a buffer) may be provided, which is for absorbing, for example, a speed difference between a conveyance speed of continuous sheet P in continuous sheet supply section 70 and a conveyance speed of continuous sheet P in image forming apparatus main body 100. Further, an adjustment device may be provided, which is for absorbing, for example, a speed difference between a conveyance speed of continuous sheet P in image forming apparatus main body 100 and a conveyance speed of continuous sheet P in continuous sheet collection section 80. The adjustment devices may be provided in the continuous sheet supply section 70 or continuous sheet collection section 80 side, and/or may be provided in the image forming apparatus main body 100 side.

The embodiments described above are merely examples of specific implementation of the present invention, and the technical scope of the present invention should not be restrictively interpreted by these embodiments. That is, the present invention may be implemented in various forms without departing from the spirit thereof or the major features thereof.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming control apparatus, comprising:
a first detector that detects an image for detection formed on a recording medium;
a second detector that detects the image for detection formed on the recording medium on a further downstream side than the first detector in a conveyance direction of the recording medium; and
a hardware processor that controls an image forming apparatus such that the image forming apparatus starts a preparation operation of image forming processing after detection in the first detector and forms an image for printing on the recording medium based on detection timing in the second detector.

2. The image forming control apparatus according to claim 1, wherein
when the second detector does not detect the image for detection within a predetermined time after the first detector detects the image for detection, the hardware processor controls the image forming apparatus such that the image forming apparatus stops forming processing of the image for printing.

3. The image forming control apparatus according to claim 1, wherein
when the first detector does not detect the image for detection, and the second detector detects the image for detection, the hardware processor controls the image forming apparatus such that the image forming apparatus stops forming processing of the image for printing.

4. The image forming control apparatus according to claim 1, wherein
the second detector has higher detection accuracy to detect the image for detection than the first detector.

5. The image forming control apparatus according to claim 1, wherein
the first detector has a larger detection range where the image for detection is detectable than the second detector.

6. The image forming control apparatus according to claim 1, wherein
the first and the second detectors detect the same image for detection.

7. The image forming control apparatus according to claim 1, further comprising a mover that moves the first detector and the second detector in conjunction with each other in a conveyance orthogonal direction which is orthogonal to the conveyance direction.

8. The image forming control apparatus according to claim 1, further comprising a speed changer that changes a conveyance speed for conveying the recording medium so that a conveyance time for conveying the recording medium from the first detector to the second detector becomes longer than a completion time for completing the preparation operation of the image forming processing.

9. The image forming control apparatus according to claim 8, wherein
when the conveyance time is shorter than the completion time, the speed changer decreases the conveyance speed to be slower than the conveyance speed in a case where the conveyance time is longer than the completion time.

10. The image forming control apparatus according to claim 9, wherein
the speed changer stops conveying the recording medium when the conveyance time is shorter than the completion time.

11. The image forming control apparatus according to claim 1, further comprising a speed changer that changes a conveyance speed for conveying the recording medium before or after detection in at least one of the first or the second detector.

12. The image forming control apparatus according to claim 11, wherein
the speed changer decreases, after the detection in the first detector, the conveyance speed to be slower than a predetermined conveyance speed before the detection in the first detector.

13. The image forming control apparatus according to claim 11, wherein
the speed changer increases, until the detection of the first detector, the conveyance speed to be faster than a predetermined conveyance speed after the detection in the first detector.

14. The image forming control apparatus according to claim 12, wherein
the speed changer restores the conveyance speed to the predetermined conveyance speed after the detection in the first detector and before the detection in the second detector.

15. An image forming apparatus, comprising:
the image forming control apparatus according to claim 1; and
an image former that forms an image for printing on a recording medium based on a control of the image forming control apparatus.
